(19) United States
(12) Patent Application Publication
(10) Pub. No.: US 2013/0131999 A1
(43) Pub. Date: May 23, 2013

(54) METHOD FOR PREDICTING CHLORIDE-INDUCED CORROSION

(71) Applicant: RAJA RIZWAN HUSSAIN, RIYADH (SA)

(72) Inventor: RAJA RIZWAN HUSSAIN, RIYADH (SA)

(73) Assignee: KING SAUD UNIVERSITY, RIYADH (SA)

(21) Appl. No.: 13/304,219

(22) Filed: Nov. 23, 2011

(51) Int. Cl. G06F 19/00; G01N 31/00

(52) U.S. Cl. 702/32

(57) ABSTRACT

The method for predicting chloride-induced corrosion, particularly corrosion of steel embedded in concrete, is based on finite-element methods and implemented in a computational program that models and evaluates various durability aspects of concrete, such as concrete hardening (hydration), microstructure formation, corrosion and several associated phenomenon, over time from the casting of the concrete to a period of several months or years, thereafter. The program includes a main model and sub-models for acquisition of data, which is used to compute coupled temperature chloride induced corrosion of steel embedded in concrete under ambient temperature. Micro-cell corrosion is computed using electric potential and current of a corrosion cell obtained from ambient conditions. Using the Arrhenius law, the method numerically evaluates temperature dependency of corrosion rates concerning steel bars embedded in concrete affected by chloride.

### BACKGROUND OF THE INVENTION

1. Field of the Invention

The present invention generally relates to the corrosion of metals, particularly in reinforced concrete, and more particularly to a method for predicting chloride-induced corrosion of steel embedded in concrete, and particularly to the dispersed individual activation energy calculation method applied to the evaluation of chloride induced corrosion in steel-reinforced concrete as affected by temperature, especially under hot weather conditions.

2. Description of the Related Art

There are many instances when it becomes desirable to measure the effect of ingredient materials, environmental conditions, as well as the size and shape of structure on the durability of concrete. Both fresh concrete problems, as well as matured concrete exposed to the environment, should be measurable to establish baseline and aging concrete structures for safety, wear and structural integrity. For example, it would be advantageous to calculate a corrosion profile of a steel-reinforced concrete structure based on concentrations of elements found in samples of the concrete structure.

Thus, a method for predicting chloride-induced corrosion solving the aforementioned problems is desired.

### SUMMARY OF THE INVENTION

The method for predicting chloride-induced corrosion of steel embedded in concrete at elevated temperature includes a finite-element method-based main computational simulation program that models and evaluates various durability aspects of concrete, such as concrete hardening (hydration), microstructure formation, corrosion and several associated phenomenon over time dating from the casting of the concrete to a period of several months or years, thereafter. As such, this tool can be utilized to study the effect of ingredient materials, environmental conditions, as well as the size and shape of structure on the durability of concrete. Durability, as considered here, takes into account both fresh concrete problems and problems with matured concrete exposed to the environment. The method analytically traces the evolution of microstructure, strength and temperature with time for any arbitrary initial and boundary conditions. Analysis of real-life concrete structures of any shape, size or configuration is achievable, since the main simulation program is based on a finite-element method.

The program includes a main model and sub-models for acquisition of data, which is used to compute coupled temperature chloride induced corrosion of steel embedded in concrete under ambient temperature. Micro-cell corrosion is computed using the electric potential and current of a corrosion cell obtained from ambient conditions. Using the Arrhenius law, the method numerically evaluates the temperature dependency of corrosion rates concerning steel bars embedded in concrete as they are affected by chloride ions.

Furthermore, dynamic coupling of several phenomena ensure that the effect of changing environmental conditions is easily integrated into the overall simulation scheme.

These and other features of the present invention will become readily apparent upon further review of the following specification and drawings.

### BRIEF DESCRIPTION OF THE DRAWINGS

FIG. 1 is a process flow diagram of a method for predicting chloride-induced corrosion according to the present invention.

FIG. 2 is a temperature vs. corrosion rate plot comparing the inventor's prior art corrosion-rate model to experimental results.

FIG. 3 is temperature vs. corrosion potential plot comparing the inventor's prior art corrosion-rate model to experimental results.

FIG. 4 is an Arrhenius plot for referential anodic current at temperatures of 20°, 40° C., and 60° C.

FIG. 5 is an Arrhenius plot for 6% Cl by mass of binder at various temperatures.

FIG. 6 is a temperature vs. corrosion rate plot comparing experiment results and model analysis results for 6% chloride after enhancement.

FIG. 7 is an Arrhenius plot for various total chloride concentrations using parameters selected by a method for predicting chloride-induced corrosion according to the present invention.

FIG. 8 is a plot of corrosion potential vs. temperature comparing the present model vs. experimental data in a chloride-induced corrosion prediction method according to the present invention.

FIG. 9 is a plot of corrosion rate vs. temperature for various chloride concentrations comparing experimental data to model profiles calculated by a method for predicting chloride-induced corrosion according to the present invention.

FIG. 10 is another plot of corrosion rate vs. temperature chloride concentrations comparing experimental data to model profiles calculated by a method for predicting chloride-induced corrosion according to the present invention.

FIG. 11 is a plot showing the relation between activation energy and chloride concentration in a corrosion reaction.

FIG. 12 is a plot of potential vs. chloride concentration describing the behavior of steel embedded in concrete.

FIG. 13 is a plot of Eₐ/R vs. chloride concentration, comparing experimental results to model predictions using a method for predicting chloride-induced corrosion according to the present invention.

FIG. 14 is a plot of Eₐ/R vs. chloride concentration, showing experimental results.

FIG. 15 is a plot of corrosion rate vs. temperature comparing experimental results with model predictions using a method for predicting chloride-induced corrosion according to the present invention.

FIG. 16 is a plot of corrosion rate vs. temperature comparing experimental results with model predictions using a method for predicting chloride-induced corrosion according to the present invention for small values of corrosion rate.

FIG. 17 is a corrosion potential vs. temperature plot for various chloride concentrations, comparing experimental results with model predictions using a chloride-induced corrosion prediction method according to the present invention.

FIG. 18 is an Arrhenius plot of variable activation energy for various chloride concentrations calculated from a model using a method for predicting chloride-induced corrosion according to the present invention.

FIG. 19 is an Arrhenius plot for a standard referential value at 20° C. for various concentrations of chloride.

FIG. 20 is a plot showing the relation between anodic current, i₀^{A}(A/m²), and chloride concentration at 20°, 40° C., and 60° C., showing the temperature dependence of anodic current in a corrosion cell.

FIG. 21 is another ΔEₐ/R vs. total chloride concentration, comparing experimental results with a sigmoidal growth equation prediction model developed in this research.

Similar reference characters denote corresponding features consistently throughout the attached drawings.

### DETAILED DESCRIPTION OF THE PREFERRED EMBODIMENTS

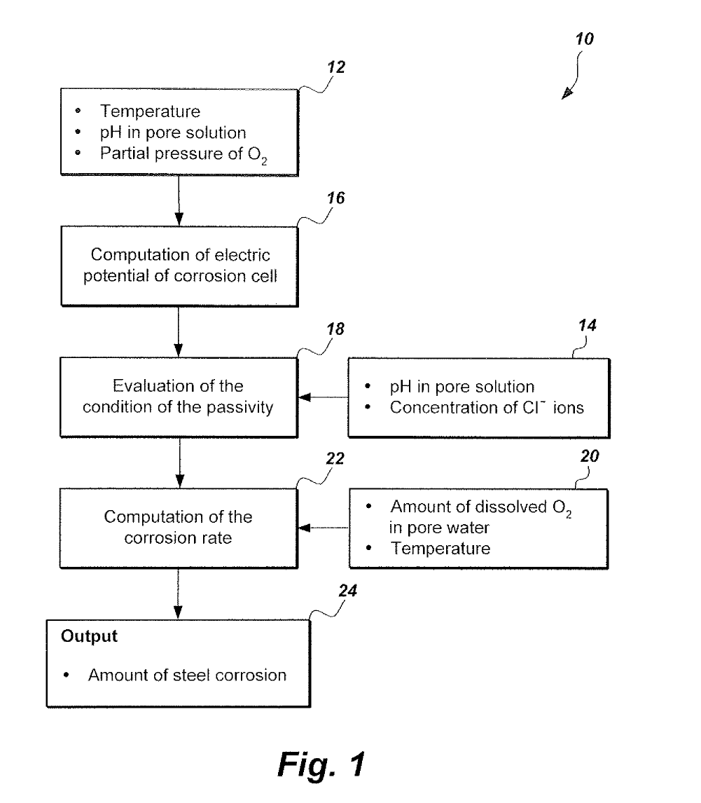

The present method for predicting chloride-induced corrosion provides a means for predicting chloride-induced corrosion of steel embedded in concrete, e.g., rebars and girders embedded in concrete, at varying temperature. A general framework of mass and ion equilibrium equations and an electro-chemical reaction model of corrosion in reinforced concrete are known in the art. Thus, the influential parameters on the theorem of corrosion process for severe environmental effects are determined experimentally and simulated in numerical terms for the enhancement of an existing model in this research. The reliability of the present model is verified through comparison of simulation with experiment results. The constituent material models employed in the durability of concrete as they relate to corrosion, shown in FIG. 1, are formulated based on micro-mechanical phenomena, such as hydration, moisture transport and cementitious microstructure formation. Their strong interrelationships are taken into account by real-time sharing of material characteristic variables across each sub-system. The non-linearity in corrosion processes and the effect of severe environmental actions is taken into account automatically in the unified framework of the present method by the help of various connected sub-models within its system to acquire the parameters necessary for computation of coupled temperature chloride induced corrosion of steel embedded in concrete under ambient temperature.

In Hussain, Raja Rizwan, and Tetsuya, Ishida, “Novel Approach Towards Calculation of Averaged Activation Energy Based on Arrhenius Plot for Modelling the Effect of Temperature on Chloride Induced Corrosion of Steel in Concrete,” Journal of ASTM International, Vol. 7, Issue 5, (May 2010), the contents of which are hereby incorporated by reference in their entirety, the present inventor adopted an overall averaged approach for calculation of activation energy of the whole electro-chemical temperature-induced corrosion modeling system. The present method for predicting chloride-induced corrosion improves upon this model by dealing with each case of chloride concentration individually and using an activation energy model based upon varying activation energies in relation to the chloride concentration and temperature.

The present method, diagrammed in the process flow diagram 10 of FIG. 1, is performed on an electronic computation device and includes the step 12 of acquiring temperature, pH in pore solution and partial pressure of O₂; the step 14 of acquiring pH in pore solution and concentration of Cl⁻ ions; the step 16 of computing electric potential of a corrosion cell; the step 18 of evaluating passivity condition; the step 20 of acquiring the amount of dissolved O₂ in pore water and acquiring temperature; the step 22 of computing a corrosion rate; and the output step 24 of outputting to a device display the amount of steel corrosion.

It will be understood that the method for predicting an amount of chloride-induced corrosion of steel in steel-reinforced concrete may be embodied in a dedicated electronic device having a microprocessor, microcontroller, digital signal processor, application specific integrated circuit, field programmable gate array, any combination of the aforementioned devices, or other device that combines the functionality of the method for predicting chloride-induced corrosion on a single chip or multiple chips programmed to carry out the method steps described herein, or may be embodied in a general purpose computer having the appropriate peripherals attached thereto and software stored on a computer readable media that can be loaded into main memory and executed by a processing unit to carry out the functionality of the apparatus and steps of the method described herein.

In the present procedural model, a general scheme of micro-cell corrosion is introduced based on electro-chemistry and classical Tafel diagram technique. The electric potential and current of corrosion cell is obtained from the ambient conditions, which are calculated by other subroutines in the system.

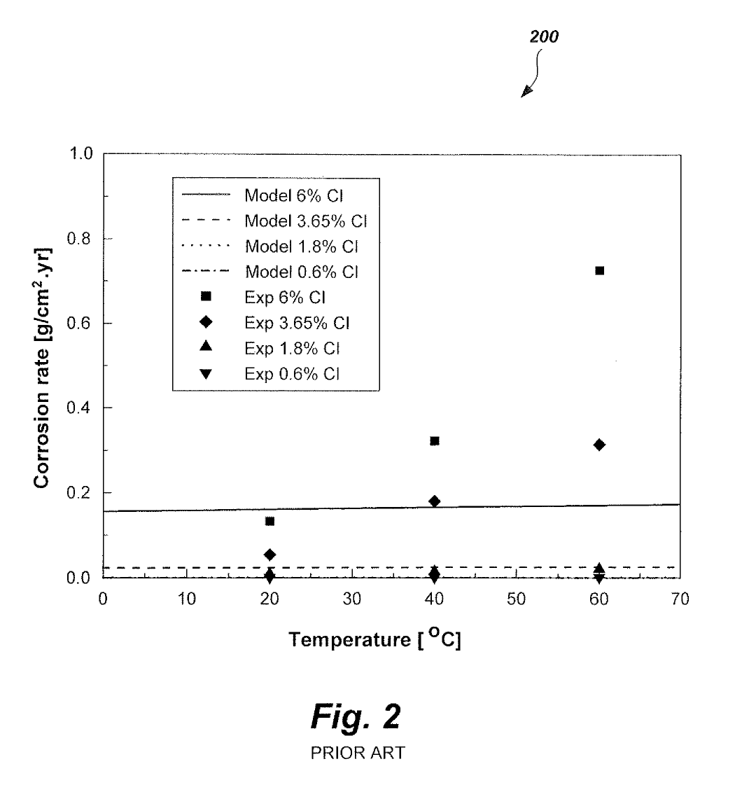

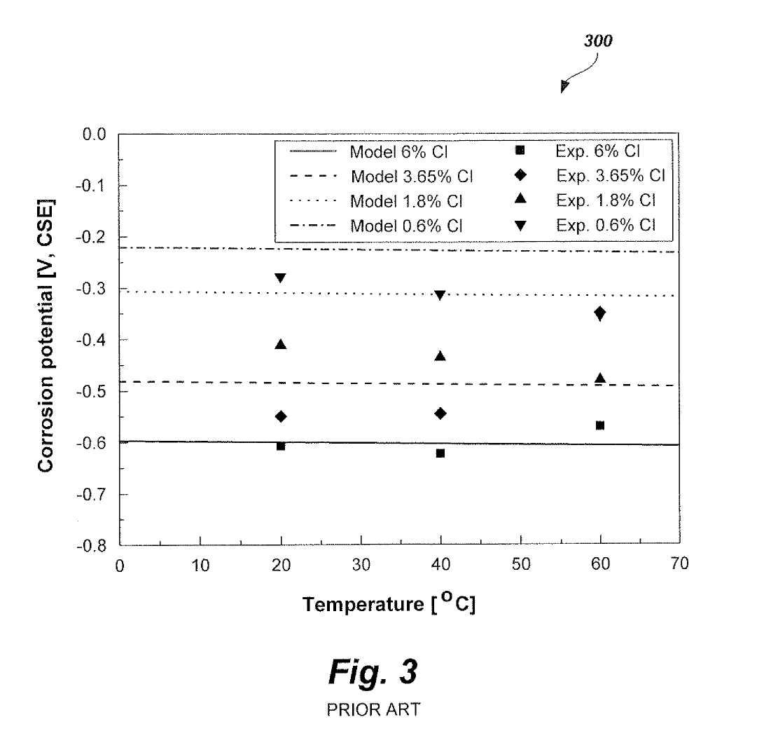

The effect of temperature in my previous corrosion model is considered from the original Nernst equations, as temperature is one of the variables in these equations. The model does account for the variation in temperature as far as the calculation of electrical potential is concerned. But, the model was primarily designed for constant normal temperature conditions for the calculation of electric current. Consequently, from the comparison of experiment results and model analysis, it can be seen that the model underestimates at high temperature conditions more than 20° C. and requires improvement, as shown in plot 200 of FIG. 2 and plot 300 of FIG. 3.

The model works satisfactorily for normal temperature conditions of 20° C. The present method extends the model for variable temperature conditions by modeling Tafel's equation derived from Arrhenius law for the estimation of temperature-induced corrosion in RC (reinforced concrete) structures. Since the corrosion of steel bars in concrete is an electrochemical process in nature, it is generally believed that the electrochemical reaction is accelerated due to temperature. Therefore it is considered that the corrosion rate of a steel bar embedded in concrete rises up as the temperature rises. The present method develops procedures that evaluate numerically and verify experimentally the temperature dependency of corrosion rates concerning steel bars embedded in concrete affected by chloride.

In general, any chemical reaction rate is theoretically described by the Arrhenius Equation (1), which expresses the fundamental law of non-linear chemical reaction rates.

A=k·exp(−ΔEₐ/RT) (1)

where A is the reaction rate, k is the frequency factor, ΔEₐ is the activation energy, R is the gas constant, and T is the absolute temperature. Equation (1) can be transformed into the logarithmic form, as shown in Equation (2).

$$ln A = - ( \frac{Δ {E}_{a}}{R} ) \cdot \frac{1}{T} + ln k \qquad ( 2 )$$

From Equation (2) it is apparent that the logarithm of the reaction rate (ln A) is proportional to the reciprocal of the absolute temperature (1/T). A diagram illustrating the relationship between the logarithm of the reaction rate and the reciprocal of the absolute temperature is called an Arrhenius plot.

In the corrosion model described herein, Nernst equations are used to calculate the respective half-cell potential values on anode and cathode sites. This is done to deal with the equilibrium conditions concerning E, pH, concentrations of ions, partial pressures of gases, and the like, so that the present procedural model can predict the effect of various parameters related to corrosion of steel in concrete. No doubt these Nernst Equations are used in the model to understand the stable phase and reactions described in E-pH diagram, or Pourbaix diagram and Tafel's diagram. But in prior models, only respective potentials and slopes are calculated with respect to temperature. The Tafel slope bₐ in the previous model increases with higher temperature, and it causes reduction in the corrosion current i_{corr}.

This is the reason for underestimation in the temperature-induced corrosion model. At a later stage, it was found that in the prior art model, not only the slope bₐ, but also the exchange electric current density at the anode, iₒ^{a}, also increases with higher temperature and needs to be incorporated in the model. The effect of temperature is much higher on iₒ^{a} than on bₐ. As a result, even though the slope bₐ increases with temperature, causing a decrease in i_{corr}, the increase in iₒ^{a} is much higher. This results in an overall increase in the corrosion current. So far in the prior art, a standard constant value of iₒ^{a} was used as 1.0×10⁻⁵ A/m². This value is satisfactory enough when one uses a constant normal temperature model for 20° C. But when it is intended to extend the model for variable temperature conditions, as contemplated by the present method, then the effect of temperature is preferably installed from the original Arrhenius Law, as shown in Equation 3 below.

i_{o(T)}^{a}=(iₒ^{a})_{∞}exp(−ΔEₐ/RT) (3)

where i_{o(T)}^{a} is the anodic current at temperature T, and (iₒ^{a})_{∞} is the ultimate reference anodic current at infinite temperature (an imaginary situation).

It is not easy to get the value of iₒ^{a} directly from experiment results only. Therefore, a back calculation of the values of iₒ^{a} at 20, 40 and 60° C. is performed by the sensitivity analysis using finite element method (FEM) durability models of concrete software in comparison to the experimental data and drawing of the Arrhenius plot for checking the applicability of the Arrhenius Law and the determination of activation energy to the corrosion rate of coupled temperature chloride induced corrosion of steel embedded in concrete.

In the back calculation of anodic current iₒ^{a} from the corrosion current i_{corr}, it is assumed that the corrosion reaction follows a reversible path under ideal conditions, that the law of mass-energy conservation is applicable, that the corrosion product is assumed to be uniform over the entire surface area of rebar, and that the formation of pits due to localized attack is not treated separately, but is given an average treatment. Considering the air dry conditions for free flow of oxygen, it is assumed that the variation in the solubility of oxygen in water due to variation in temperature will not have a significant effect on the cathodic slope b_{c}. Thus, same value of cathodic slope has been used as in the constant temperature model earlier. The effect of concentration polarization and other non-equilibrium processes remains for future research. Overall, a simplified and practical methodology is adopted herein.

The referential temperature has been set at 20° C., and the standard value of iₒ^{a}=1.0×10⁻⁵ A/m², which was used as a constant value of anodic current in the original model, has been set as the referential value of anodic current at 20° C. in the present enhanced procedural model. Equation (4), for the setting of referential values, is characterized by the relation:

i_{o(T)}^{a}=i_{o(Ts)}^{a}exp[−ΔEₐ/R(1/T−1/Tₛ)] (4)

where:

i_{o(Ts)}^{a}=(iₒ^{a})_{∞} exp[ΔEₐ/R(1/Tₛ)]

In Equation (4), the value of the referential anodic current i_{o(Ts)}^{a} is equal to i_{o(20° C.)}^{a}=1.0×10⁻⁵ A/m². This enhanced model, derived from the Arrhenius law, gives the direct relation between the anodic current iₒ^{a} and any arbitrary temperature T.

As there is no way to measure the value of iₒ^{a} directly from experimentation, therefore, the referential values of in at 40° C. and 60° C. are back-calculated by using the standard referential value of iₒ^{a}=1.0×10⁻⁵ A/m² at 20° C., along with sensitivity analysis on the corrosion model.

Originally the back calculation is done starting from the corrosion current and potential. Corrosion potential is obtained as direct measurement, while corrosion current is obtained from the gravimetric mass loss measurement in the experiment by using Faraday's law. Then, using the Nernst Equation in the model and comparison of experiment results and analysis (plot 200 of FIG. 2 and plot 300 of FIG. 3), the respective values of anodic current iₒ^{a} at 40° C. and 60° C. are back-calculated by performing sensitivity analysis by FEM, so that the model analysis and experiment results become coherent on an averaged basis for all the available cases of variable chloride and temperature conditions.

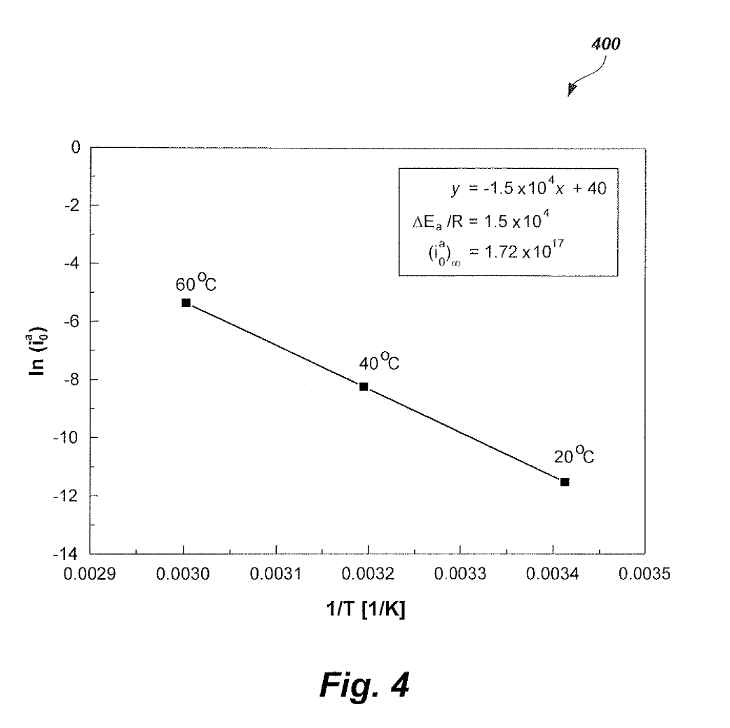

The anodic current values iₒ^{a} obtained as above were plotted against the inverse of absolute temperature to obtain an Arrhenius plot. The Arrhenius plot came out to be a straight line (as shown in plot 400 of FIG. 4), thus proving that the Arrhenius Law is applicable and the present proposed method is valid.

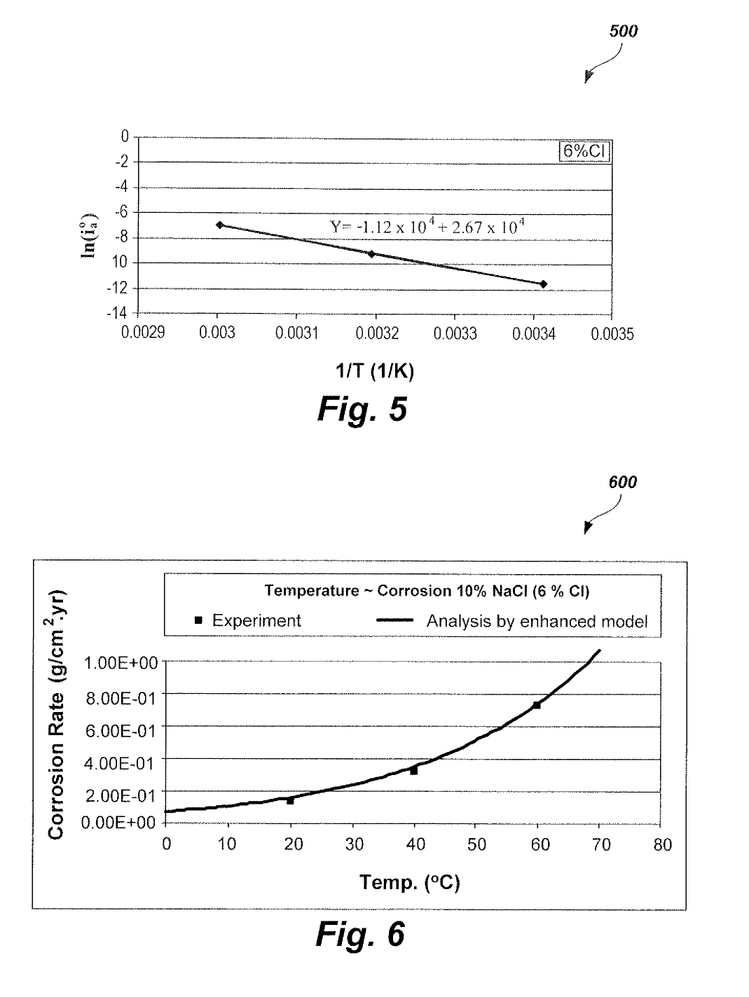

By the methodology discussed above, the anodic current values iₒ^{a} were obtained for one extreme case of chloride concentration, i.e., 6% total chloride by mass of binder, and plotted against the inverse of absolute temperature to obtain the Arrhenius plot for one individual case. It was observed that the Arrhenius plot again came out to be a perfect straight line (plot 500 of FIG. 5), even for an individual case, thus proving again that the Arrhenius Law is applicable, and that an individual dispersed activation energy enhancement method is valid. As is evident from FIG. 5, the rate of increase of iₒ^{a} with temperature follows the Arrhenius Law. Thus, the activation energy can now be obtained for this individual case as well. From this Arrhenius plot, the activation energy of reaction is ΔEₐ=1.12×10⁴×R, and the referential value (iₒ^{a})_{∞}, which is the ultimate reference anodic current at infinite temperature, is calculated as (iₒ^{a})_{∞}=4.04×10¹¹.

The FEM corrosion model shows good agreement with the experiment results (plot 600 of FIG. 6) for the effect of temperature on corrosion of steel reinforcement embedded in concrete for 6% chloride concentration. Thus, this provides evidence for the efficiency and accuracy of the proposed individual dispersed modeling computational approach. Plots 500 of FIGS. 5 and 600 of FIG. 6 explain the overall picture of above methodology adopted in this research. It explains the applicability of the Arrhenius law and validity of the present procedure, the results of Arrhenius plot and the linear relation obtained, calculation of activation energy, its application for the prediction of temperature-induced corrosion in RC structures, and finally, the comparison of experiment results and analysis, which shows a good match.

In order to apply the enhanced temperature model to varying percentage of chloride concentrations, Arrhenius plots are made on similar lines, as explained above, for various cases of chloride concentrations and analyzed individually, as well as in comparison to each other.

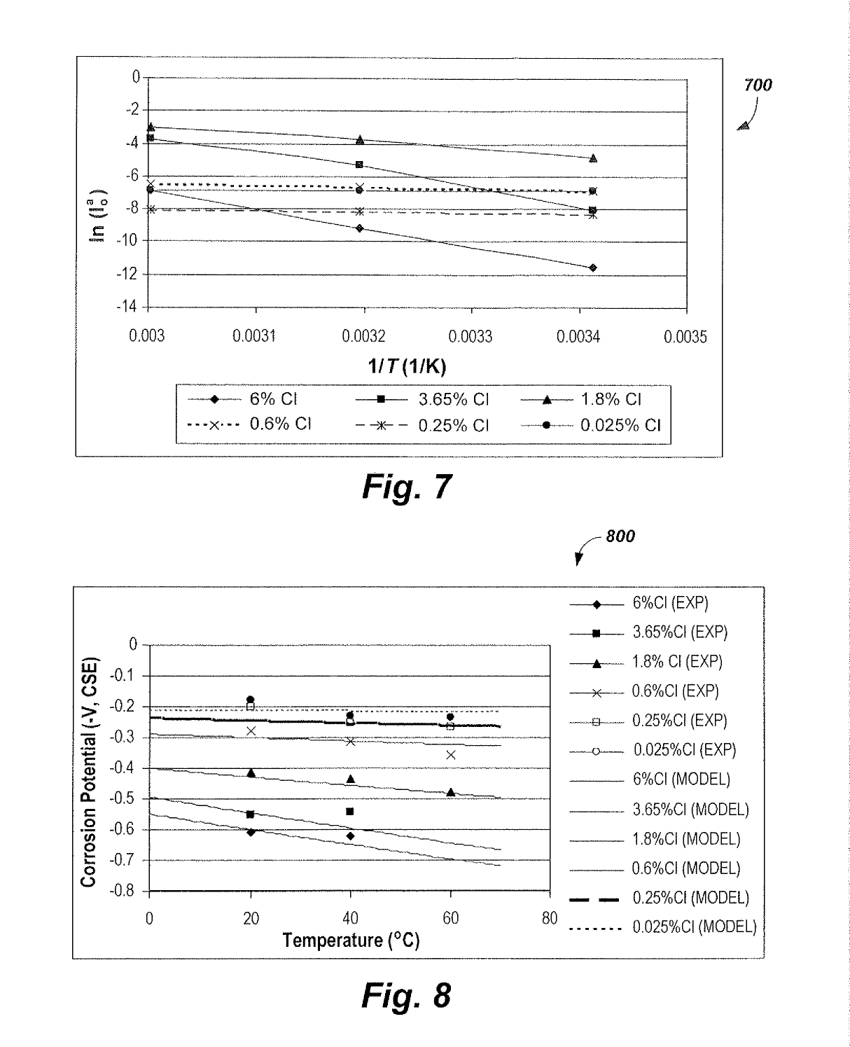

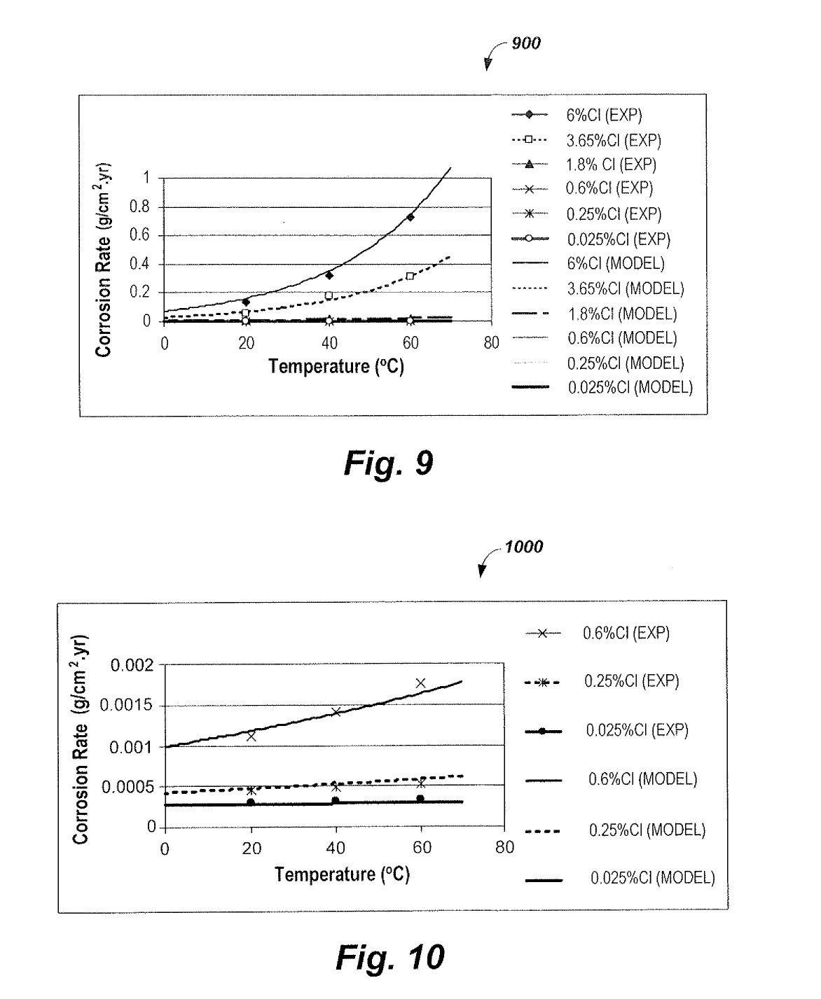

It can be seen that all the chloride cases show linear Arrhenius plots (as shown in plot 700 of FIG. 7) and for these Arrhenius plots, model analysis and experiment results show a perfect match (as shown in plot 800 of FIG. 8, plot 900 of FIG. 9, and plot 1000 of FIG. 10). Thus, the Arrhenius Law is applicable, and the present method is valid for various individual and dispersed chloride concentration cases. But comparison of the Arrhenius plots with each other illustrates that the activation energies are different for different cases of chloride concentrations.

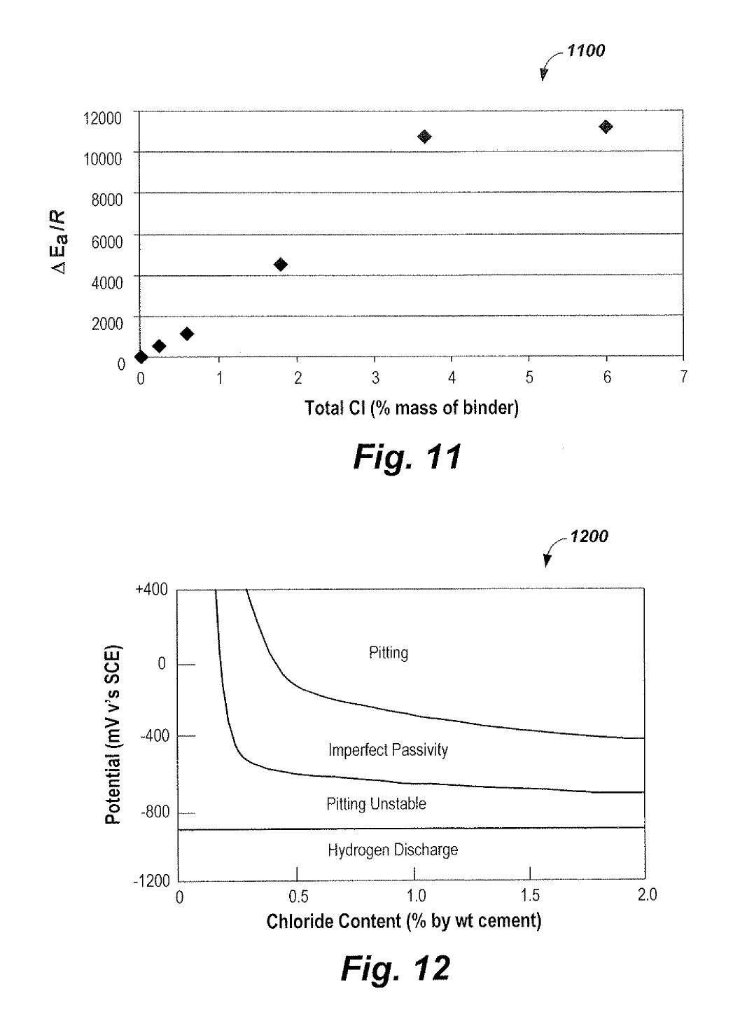

To understand the behavior of activation energy in a coupled temperature chloride induced corrosion reaction, the activation energy profile as a function of chloride content is extracted from plot 700 of FIG. 7 and presented as plot 1100 of FIG. 11, which explains the non-linear individual dispersed activation energy behavior. From this profile, it can be seen that activation energy is directly proportional to the increase in chloride concentration. The reason lies in the nature of the effect of chloride on corrosion reaction. Principally, the activation energy is independent of the amount of reactants and products. But, in fact, chloride is not the main reactant or product of corrosion reaction, and the function of chloride is to make the initiation only by indirect reaction with the passive layer.

The exact methodology and equilibrium equations involved in the attack of chloride on the passive layer are still unknown to the researchers, and inherit a difference of opinion. As shown in plot 1200 of FIG. 12, it can be seen that the electrochemical behavior of steel bar varies with concentration of chloride in concrete. Thus, different levels of chloride concentration can change the nature of the corrosion reaction. In other words, the type of reactants and products involved in the corrosion reaction changes with varying concentration of chlorides in concrete. Thus, ultimately different amounts of chloride concentration result in different amounts of activation energies in the corrosion reaction of steel in concrete.

The relation between activation energy and chloride content in the corrosion reaction is analyzed on theoretical grounds, and it is revealed that it follows the sigmoidal growth equation (5):

Y=A−(A−B)e^{-(kX)d} (5)

where Y=ΔEₐ/R, X=Total Cl (% mass of binder), A, B, k and d are constants, and wherein A=11294, 400, k 0.42, and d=2.45.

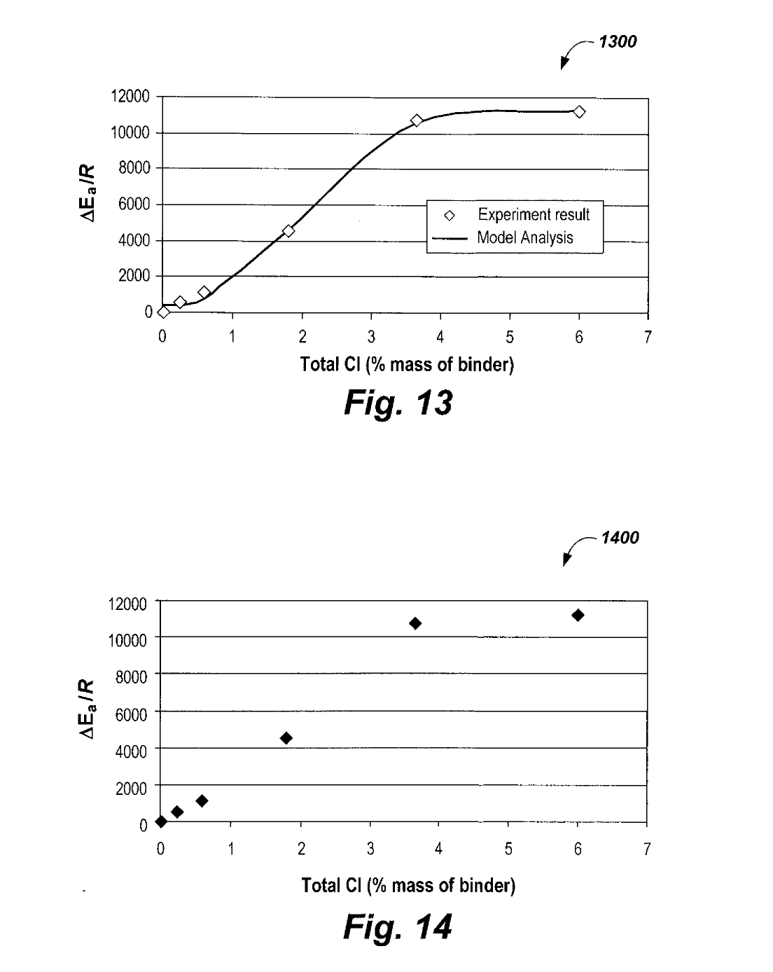

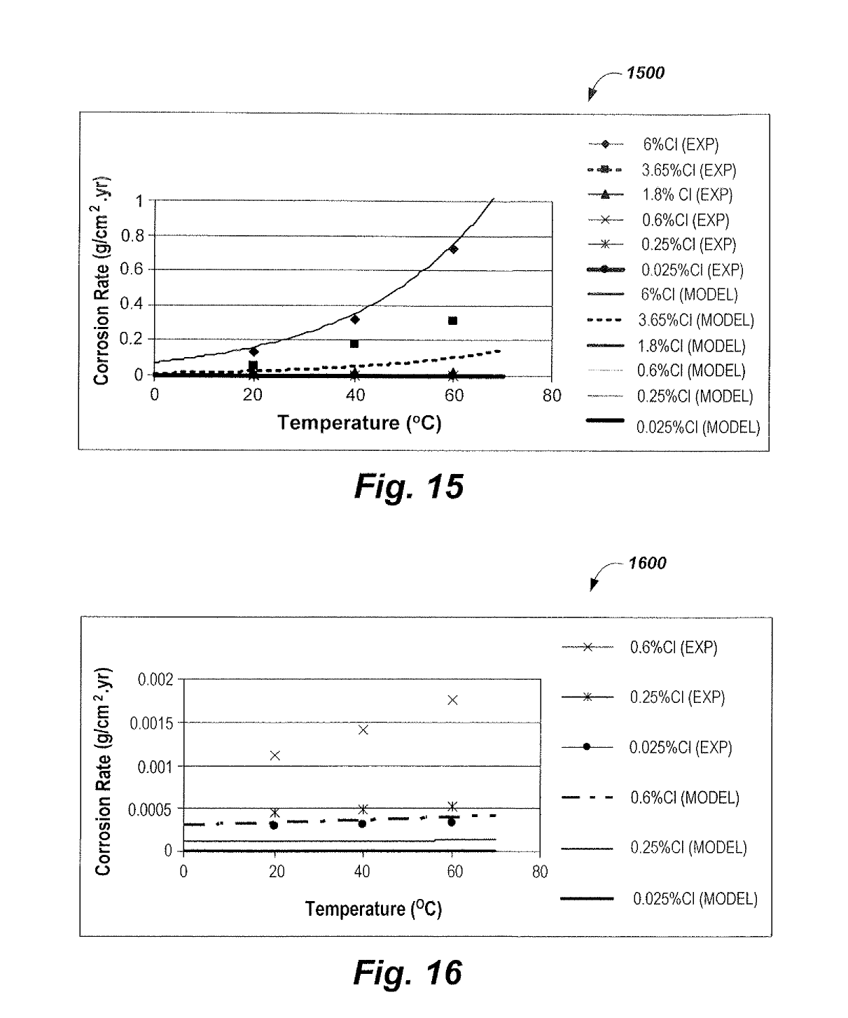

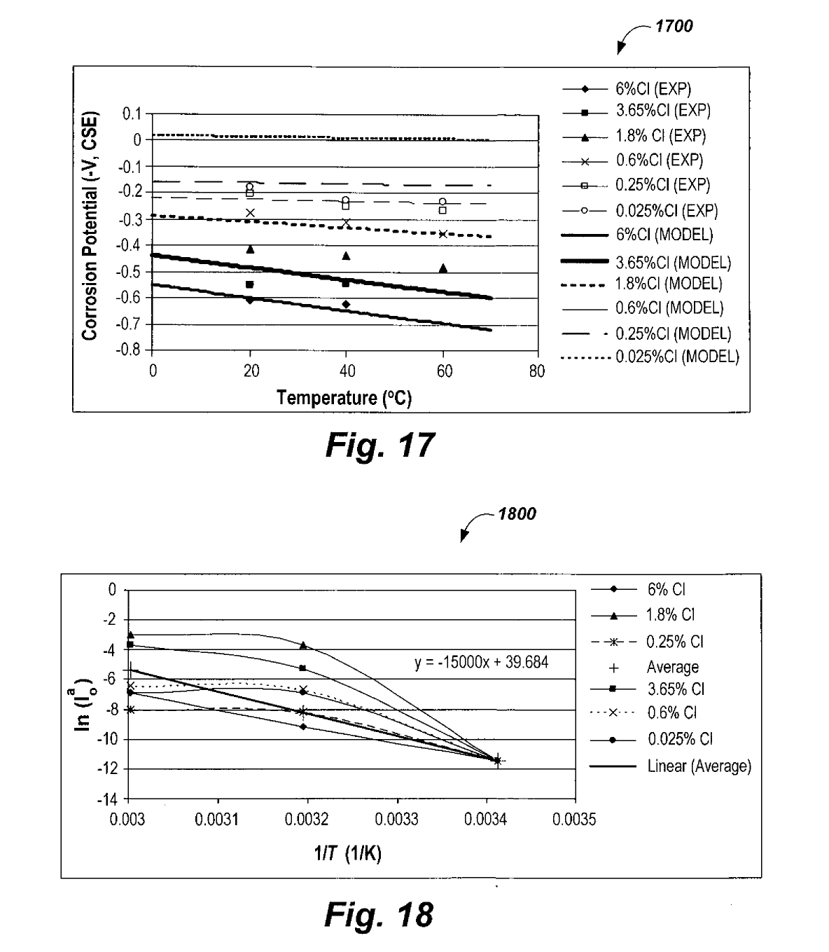

The comparison of analysis by Eq. 5 and experiment results shows good agreement, as illustrated in plot 1300 of FIG. 13. Plot 1400 of FIG. 14 illustrates additional cases solved by the present method. Using the present procedural model and the standard value of iₒ^{a}=1.0×10-5 A/m2 as the referential value of anodic current at 20° C., which was used as a constant value of anodic current in the original model, the experiment results and model analysis is compared for corrosion current and potential values in plot 1500 of FIG. 15, plot 1600 of FIG. 16 and plot 1700 of FIG. 17. It can be seen that, except for the case of 6% total chloride content, all other cases do not show good agreement between the experimental results and model analysis. This is because the standard value of iₒ^{a}=1.0×10⁻⁵ A/m² at 20° C. matches with the iₒ^{a} of 6% chloride case, but is different for other cases of chloride concentration and temperature conditions (see FIG. 7). This problem is solved by the method described herein.

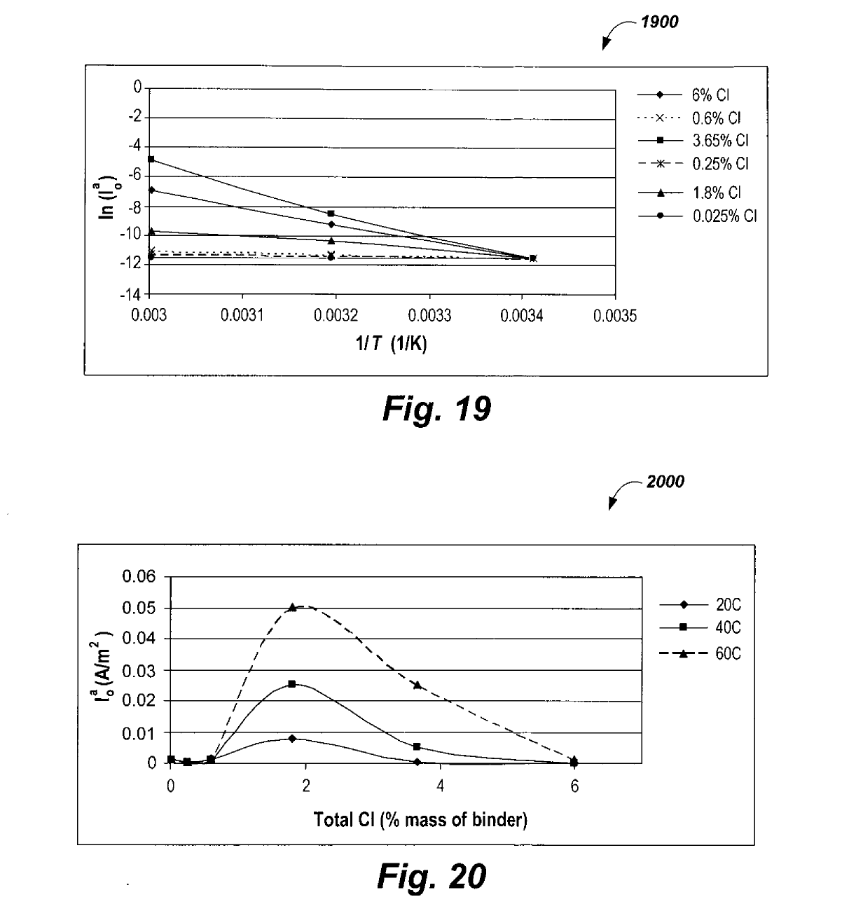

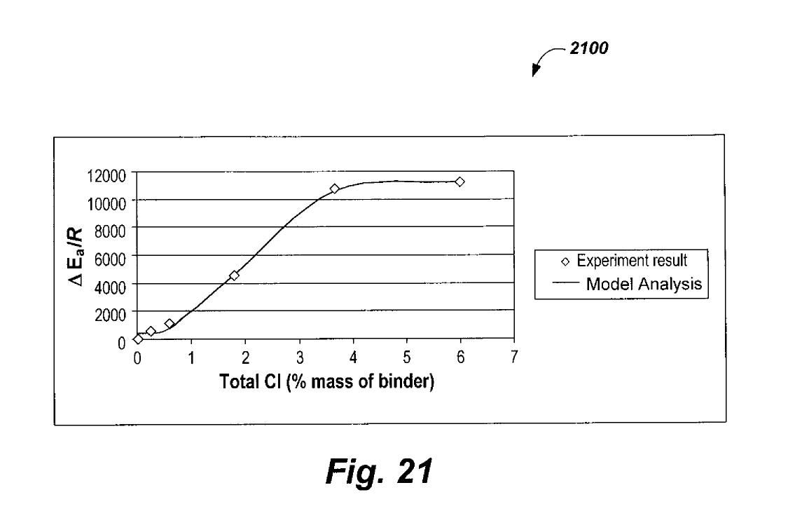

When the same value of iₒ^{a} is used for all cases of chloride concentration, then the situation shown in plot 1800 of FIG. 18 and plot 1900 of FIG. 19 is obtained. Investigations revealed that, in fact, iₒ^{a} is also varying as a function of chloride concentration and temperature. This relation is extracted from FIG. 7 and presented in plot 2000 of FIG. 20, which shows that iₒ^{a} in is not only a function of chloride concentration, but also is a function of temperature. Yet it is very interesting to observe the similarity present in the profiles of iₒ^{a} at different temperature conditions of 20° C., 40° C. and 60° C. Plot 2100 of FIG. 21 illustrates the above conceptual formulations.

It is to be understood that the present invention is not limited to the embodiments described above, but encompasses any and all embodiments within the scope of the following claims.

I claim:

1. An electronic computation device-implemented method for predicting an amount of chloride-induced corrosion of steel in reinforced concrete, comprising the steps of:
acquiring temperature, pore solution pH and partial pressure of O₂ data from a sample of the steel-reinforced concrete;
acquiring Cl⁻ ion concentration data from the concrete sample;
computing electric potential of a corrosion cell inside the steel-reinforced concrete sample;
evaluating a condition of passivity from the sample;
acquiring amount of dissolved O₂ in pore water;
to computing a corrosion rate of the sample using a modified Arrhenius equation characterized by the relation:
i_{o(T)}^{a}=(iₒ^{a})_{∞}exp(−ΔEₐ/RT),
where i_{o(T)}^{a} is the anodic current at temperature T, ΔEₐ is activation energy, R is the ideal gas constant, and (iₒ^{a})_{∞}is 4.04×10¹¹, an ultimate reference anodic current at infinite temperature; and
displaying on the electronic computation device an amount of steel corrosion and an amount of consumed O₂ associated with the steel-reinforced concrete sample.

2. The electronic computation device-implemented method according to claim 1, further comprising the step of setting a referential temperature at 20° C. and a standard value of iₒ^{a}=1.0×10⁻⁵ A/m², where iₒ^{a} is anodic exchange current density of a corrosion cell of the sample.

3. The electronic computation device-implemented method according to claim 2, wherein said referential temperature setting step further comprises setting said referential values according to an equation characterized by the relation,
i_{o(T)}^{a}=i_{o(Ts)}^{a}exp[−ΔEₐ/R(1/T−1/Tₛ)],
where i_{o(Ts)}^{a}=(iₒ^{a})_{∞} exp[ΔEₐ/R(1/Tₛ)], thereby yielding a direct relation between the anodic current iₒ^{a} and any arbitrary temperature T.

4. The electronic computation device-implemented method according to claim 3, further comprising the step of computing a relation between activation energy and chloride content in the sample, the activation energy/chloride content relation being characterized by a sigmoidal growth equation:
Y=A−(A−B)e^{-(kX)d},
wherein Y=ΔEₐ/R, X=Total Cl (% mass of binder), A, B, k and d are constants, and wherein A=11294, B=400, k=0.42, and d=2.45.

5. The electronic computation device-implemented method according to claim 1, further comprising the step of transforming the Arrhenius equation relation into a logarithmic form used by the electronic computation device, the logarithmic form being characterized by the Tafel relation:
$$ln A = - ( \frac{Δ {E}_{a}}{R} ) \cdot \frac{1}{T} + ln k ,$$
wherein k is a frequency factor and A is a reaction rate.

6. The electronic computation device-implemented method according to claim 1, further comprising the step of back-calculating values of iₒ^{a} is at 20, 40 and 60° C., respectively.

7. A computer software product, comprising a medium readable by a processor, the medium having stored thereon a set of instructions for predicting an amount of chloride induced corrosion of steel in steel-reinforced concrete, the set of instructions including:
(a) a first sequence of instructions which, when executed by the processor, causes said processor to acquire temperature, pore solution pH and partial pressure of O₂ data from a sample of the steel-reinforced concrete;
(b) a second sequence of instructions which, when executed by the processor, causes said processor to acquire Cl⁻ ion concentration data from the concrete sample;
(c) a third sequence of instructions which, when executed by the processor, causes said processor to compute electric potential of a corrosion cell inside the steel-reinforced concrete it sample;
(d) a fourth sequence of instructions which, when executed by the processor, causes said processor to evaluate a condition of passivity from the sample;
(e) a fifth sequence of instructions which, when executed by the processor, causes said processor to acquire amount of dissolved O₂ in pore water;
(f) a sixth sequence of instructions which, when executed by the processor, causes said processor to compute a corrosion rate of the sample using a modified Arrhenius equation characterized by the relation:
i_{o(T)}^{a}=(iₒ^{a})_{∞}exp(−ΔEₐ/RT),
where i_{o(T)}^{a} is the anodic current at temperature T, ΔEₐ is activation energy, R is the ideal gas constant, and (iₒ^{a)}_{∞} is 4.04×10¹¹, an ultimate reference anodic current at infinite temperature; and
(g) a seventh sequence of instructions which, when executed by the processor, causes said processor to display an amount of steel corrosion and an amount of consumed O₂ associated with the steel-reinforced concrete sample.

8. The computer software product according to claim 7, further comprising an eighth sequence of instructions which, when executed by the processor, causes said processor to set a referential temperature at 20° C. and a standard value of iₒ^{a}=1.0×10⁻⁵ A/m², where iₒ^{a} is anodic exchange current density of a corrosion cell of the sample.

9. The computer software product according to claim 8, further comprising an eleventh sequence of instructions which, when executed by the processor, causes said processor to set the referential values according to an equation characterized by the relation:
iₒ_{_{(T)}}^{a}=iₒ_{_{(Ts)}}^{a}exp[−ΔEₐ/R(1/T−1/Tₛ)],
wherein iₒ_{_{(Ts)}}^{a=(i}ₒ^{a})_{∞} exp[−ΔEₐ/R(1/Tₛ)], thereby yielding a direct relation between the anodic current iₒ^{a} and any arbitrary temperature T.

10. The computer software product according to claim 9, further comprising a twelfth sequence of instructions which, when executed by the processor, causes said processor to compute a relation between activation energy and chloride content in said sample, said activation energy/chloride content relation being characterized by a sigmoidal growth equation:
Y=A−(A−B)e^{-(kX)d},
wherein Y=ΔEₐ/R, X=Total. Cl (% mass of binder), A, B, k and d are constants, and wherein A=11294, B=400, k=0.42, and d=2.45.

11. The computer software product according to claim 7, further comprising a ninth sequence of instructions which, when executed by the processor, causes said processor to transform the Arrhenius equation relation into a logarithmic form used by the processor, the logarithmic form being characterized by the Tafel relation,
$$ln A = - ( \frac{Δ {E}_{a}}{R} ) \cdot \frac{1}{T} + ln k ,$$
wherein k is a frequency factor and A is a reaction rate.

12. The computer software product according to claim 7, further comprising a tenth sequence of instructions which, when executed by the processor, causes said processor to back-calculate values of iₒ^{a} at 20, 40 and 60° C., respectively.
